(19) United States
(12) Patent Application Publication
(10) Pub. No.: US 2021/0164537 A1
(43) Pub. Date: Jun. 3, 2021

(54) BALANCE SHAFT SUPPORT STRUCTURE

(71) Applicants: HYUNDAI MOTOR COMPANY, SEOUL (KR); KIA MOTORS CORPORATION, SEOUL (KR)

(72) Inventors: Ahn Lee, Seoul (KR); Jaekyun Lee, Hwaseong-si (KR); Kee Myoung Moon, Seongnam-si (KR); Kye Oong Song, Yongin-si (KR)

(21) Appl. No.: 16/943,492

(22) Filed: Jul. 30, 2020

(30) Foreign Application Priority Data
Nov. 28, 2019 (KR) 10-2019-0155814

(51) Int. Cl. F16F 15/26

(52) U.S. Cl. CPC F16F 15/267

(57) ABSTRACT

A balance shaft support structure includes a bearing portion coupled with a cylinder block, and a rubber damper interposed between the bearing portion and a balance shaft journal to prevent vibration transmission of the balance shaft.

### CROSS REFERENCE TO RELATED APPLICATIONS

This application claims priority to and the benefit of Korean Patent Application No. 10-2019-0155814 filed in the Korean Intellectual Property Office on Nov. 28, 2019, the entire contents of which are incorporated herein by reference.

### BACKGROUND

### (a) Field

The present disclosure relates to a balance shaft support structure. More particularly, the present disclosure relates to a balance shaft support structure that attenuates vibration caused by dynamic operation.

### (b) Description of the Related Art

In engine development, suppression performance such as noise/vibration, as well as durability and power performance are important factors due to the customer's demands extending not only to the basic engine durability and power performance, but also to NVH performance.

The balance shaft, along with the crankshaft, is one of the engine's most important vibration sources. A needle bearing is applied to a general balance shaft, and vibration of the balance shaft can be transmitted to the cylinder block as it is.

The balance shaft disposed inside the engine is manufactured in an elongated shape due to space constraints, which can lead to the occurrence of a rattle impact sound by vibration due to radial direction deformation. Vibration of cylinder block causes noise by exciting the skirt part (thin thickness area) and an oil pan of the block.

In order to improve engine quietness, sound absorbing and insulating materials can be applied to noise generating parts such as the block and the oil pan, but this causes a cost/weight increase.

The above information disclosed in this Background section is only for enhancement of understanding of the background of the disclosure, and therefore it may contain information that does not form the prior art that is already known in this country to a person of ordinary skill in the art.

### SUMMARY

The present disclosure has been made in an effort to provide a balance shaft support structure that attenuates vibration by a balance shaft dynamic operation.

A balance shaft support structure according to an exemplary embodiment of the present disclosure may include a bearing portion coupled with a cylinder block, and a rubber damper interposed between the bearing portion and a balance shaft journal to prevent vibration transmission of the balance shaft, and the bearing portion may include an external bush connected to the cylinder block, a guide bush provided inside the external bush, and a roller portion including a roller and a roller cage interposed between the external bush and the guide bush.

The balance shaft support structure may further include a bush flange formed at one end of the guide bush to prevent separation of the roller portion by supporting one end of the roller portion.

The balance shaft may include a shaft flange protruded in the diameter direction, wherein the shaft flange may support the other end of the roller portion.

The rubber damper may be secured to the balance shaft journal by vulcanizing adhesive.

The balance shaft support structure may further include a base bush interposed between the rubber damper and the balance shaft journal.

The base bush may be press fitted into the balance shaft journal.

A balance shaft support structure according to an exemplary embodiment of the present disclosure may include an external bush coupled to a cylinder block, a roller portion including a roller and a roller cage provided inside the external bush, a guide bush provided inside the roller portion to support rotation of the roller portion and to limit movement of the roller portion in an axial direction thereof, and a rubber damper interposed between the guide bush and a balance shaft journal to prevent vibration transmission of balance shaft.

The balance shaft support structure may further include a bush flange formed at one end of the guide bush supporting one end of the roller portion.

The balance shaft may include a shaft flange protruded in the diameter direction, wherein the shaft flange may support the other end of the roller portion.

The rubber damper may be secured to the balance shaft journal by vulcanizing adhesive.

The balance shaft support structure may further include a base bush interposed between the rubber damper and the balance shaft journal.

The base bush may be press fitted into the balance shaft journal.

The balance shaft support structure according to an exemplary embodiment of the present disclosure may attenuate vibration caused by dynamic operation.

### BRIEF DESCRIPTION OF THE FIGURES

FIG. 1 is an exploded perspective view of a balance shaft support structure according to an exemplary embodiment of the present disclosure.

FIG. 2 is a cross-sectional view of a balance shaft support structure according to an exemplary embodiment of the present disclosure.

FIG. 3 is a cross-sectional view of a balance shaft support structure according to a modified exemplary embodiment of the present disclosure.

### DETAILED DESCRIPTION

In the following detailed description, only certain exemplary embodiments of the present disclosure have been shown and described, simply by way of illustration.

As those skilled in the art would realize, the described embodiments may be modified in various different ways, all without departing from the spirit or scope of the present disclosure

Parts indicated by the same reference number throughout the specification mean the same constituent elements.

In the drawings, the thickness of layers, films, panels, regions, etc., are exaggerated for clarity.

When a part of a layer, film, region, plate, etc. is said to be “above” another part, this includes not only directly above the other part but also another part in the middle.

In contrast, when an element is referred to as being “directly on” another element, there are no intervening elements present.

Throughout the specification and the claims, unless explicitly described to the contrary, the word “comprise” and variations such as “comprises” or “comprising”, will be understood to imply the inclusion of stated elements but not the exclusion of any other elements.

An exemplary embodiment of the present disclosure will hereinafter be described in detail with reference to the accompanying drawings.

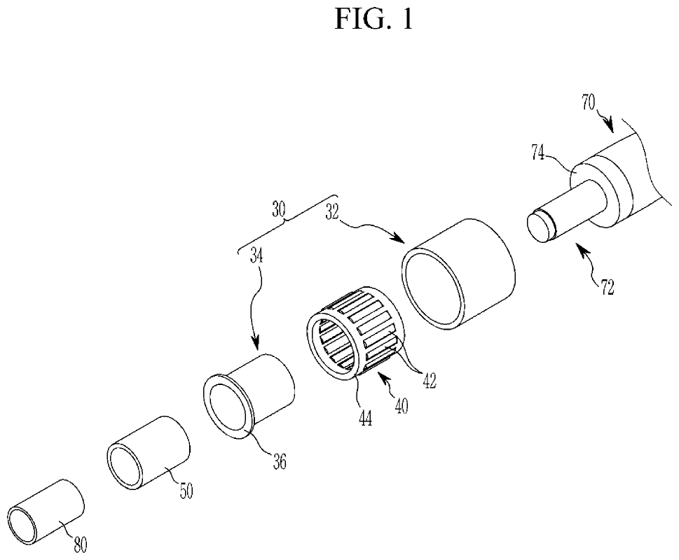

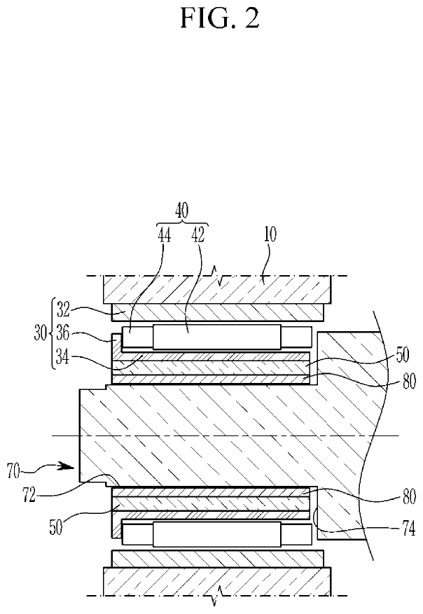

FIG. 1 is an exploded perspective view of a balance shaft support structure according to an exemplary embodiment of the present disclosure and FIG. 2 is a cross-sectional view of a balance shaft support structure according to an exemplary embodiment of the present disclosure.

Referring to FIG. 1 and FIG. 2, a balance shaft support structure according to an exemplary embodiment of the present disclosure may include a bearing portion 30 coupled with a cylinder block 10, and a rubber damper 50 interposed between the bearing portion 30 and a balance shaft journal 72 to prevent vibration transmission of the balance shaft 70.

The bearing portion 30 may include an external bush 32 connected to the cylinder block 10, a guide bush 34 provided inside the external bush 32, and a roller portion 40 including a roller 42 and a roller cage 44 interposed between the external bush 32 and the guide bush 34.

The balance shaft support structure may further include a bush flange 36 formed at one end of the guide bush 34 to prevent separation of the roller portion 40 by supporting one end of the roller portion 40.

In other words, according to the balance shaft support structure of the exemplary embodiment of the present disclosure, the cylinder block 10 is coupled to the external bush 32, the external bush 32 is provided with the roller portion 40 including the roller 42 and the roller cage 44 inside, and the guide bush 34, which supports the rotation of the roller portion 40 and restricts the movement of the roller portion 40 in the axial direction is disposed within the roller portion 40. A rubber damper 50 is interposed between the guide bush 34 and a balance shaft journal 72 to prevent vibration transmission of balance shaft 70.

The balance shaft 70 may include a shaft flange 74 protruding in the diameter or lateral direction, and the shaft flange 74 may support the other end of the roller portion 40. Therefore, movement in the axial direction of the roller portion 40 is restricted by the bush flange 36 and the shaft flange 74.

The balance shaft support structure may further include a base bush 80 interposed between the rubber damper 50 and the balance shaft journal 72.

The base bush 80 may be press fitted into the balance shaft journal 72. That is, the assembly of the guide bush 34, the rubber damper 50 and the base bush 80 can be fixed to the balance shaft 70 by the press fitting of the base bush 80.

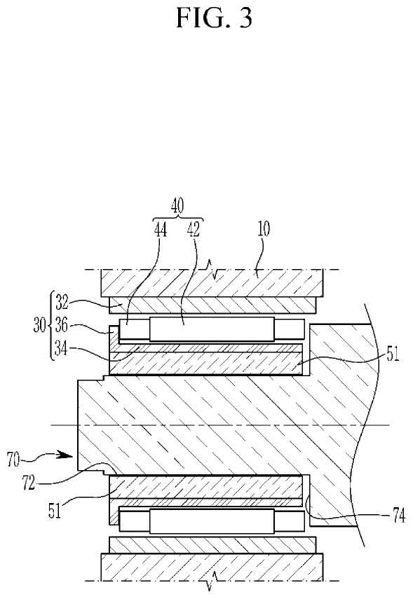

FIG. 3 is a cross-sectional view of a balance shaft support structure according to a modified exemplary embodiment of the present disclosure.

In explaining the balance shaft support structure according to the modified embodiment of the present disclosure shown in FIG. 3, the same reference numerals for the same configuration as the balance shaft support structure according to an embodiment of the present disclosure shown in FIG. 1 and FIG. 2 are used, and repeated descriptions are omitted.

The balance shaft support structure according to the modified embodiment of the present disclosure shown in FIG. 3 includes a rubber damper 51 elastically supporting the bearing part 30, and the rubber damper 51 may be secured to the balance shaft journal 72 by vulcanizing adhesive.

The rubber damper 51 is vulcanized to the balance shaft journal 72, reducing the number of parts.

According to the balance shaft support structure according to one or a plurality of exemplary embodiments of the present disclosure, vibration transmitted to the cylinder block can be reduced by reducing vibration amplitude and damping of the balance shaft.

In addition, applying a vulcanized type rubber shape can increase the rubber volume in the same shape, further reducing strength and improving vibration insulation performance.

According to the balance shaft support structure according to one or a plurality of exemplary embodiments of the present disclosure, it is possible to reduce the NVH and the cost by reducing the sound absorbing and insulating material mounted outside the engine. While this disclosure has been described in connection with what is presently considered to be practical exemplary embodiments, it is to be understood that the disclosure is not limited to the disclosed embodiments. On the contrary, it is intended to cover various modifications and equivalent arrangements included within the spirit and scope of the appended claims.

1. A balance shaft support structure comprising:
a bearing portion coupled to a cylinder block; and
a rubber damper positioned between the bearing portion and a balance shaft journal to prevent vibration transmission of the balance shaft;
wherein the bearing portion comprises:
an external bush connected to the cylinder block;
a guide bush positioned inside the external bush; and
a roller portion including a roller and a roller cage positioned between the external bush and the guide bush;
wherein a bush flange is formed outwardly at one end of the guide bush to prevent separation of the roller portion by supporting one end of the roller portion.

2. (canceled)

3. The balance shaft support structure of claim 1, wherein the balance shaft includes a shaft flange protruding in diameter lateral direction, and wherein the shaft flange supports an other end of the roller portion.

4. The balance shaft support structure of claim 1, wherein the rubber damper is secured to the balance shaft journal by vulcanizing adhesive.

5. The balance shaft support structure of claim 1, further comprising a base bush positioned between the rubber damper and the balance shaft journal.

6. The balance shaft support structure of claim 5, wherein the base bush is press fitted into the balance shaft journal.

7. A balance shaft support structure comprising:
an external bush coupled to a cylinder block;
a roller portion including a roller and a roller cage positioned inside the external bush;
a guide bush positioned inside the roller portion to support rotation of the roller portion and to limit movement of the roller portion in an axial direction thereof; and
a rubber damper positioned between the guide bush and a balance shaft journal to prevent vibration transmission of balance shaft
wherein a bush flange is formed outwardly at one end of the guide bush supporting one end of the roller portion.

8. (canceled)

9. The balance shaft support structure of claim 7, wherein the balance shaft includes a shaft flange protruded in a lateral direction, and wherein the shaft flange supports an other end of the roller portion.

10. The balance shaft support structure of claim 7, wherein the rubber damper is secured to the balance shaft journal by vulcanizing adhesive.

11. The balance shaft support structure of claim 7, further comprising a base bush positioned between the rubber damper and the balance shaft journal.

12. The balance shaft support structure of claim 7, wherein the base bush is press fitted into the balance shaft journal.
